(19) United States
(12) Patent Application Publication
(10) Pub. No.: US 2006/0221480 A1
(43) Pub. Date: Oct. 5, 2006

(54) Digital data recording method and digital data recording apparatus

(76) Inventor: Taku Hoshizawa, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/253,699

(22) Filed: Oct. 20, 2005

(30) Foreign Application Priority Data
Apr. 4, 2005 (JP) 2005-107017

(51) Int. Cl. G11B 5/09

(52) U.S. Cl. 360/48

(57) ABSTRACT

A plural-channel simultaneous recording of AV data by using a DVD recorder is provided. The plural-channel simultaneous recording is executed while suppressing a fluctuation of a video image and an audio sound occurring upon recording and reproduction of the AV data in which real-time streaming performance is required in recording and reproduction. In a digital data recording method of recording digital data of a plurality of channels onto an optical disk as an embodiment, parameters including a use minimum contiguous recording area size and a maximum skipped contiguous ECC block number and a recording area per channel are set. In response to a recording request including channel information, the digital data is contiguously recorded into the recording area of the channel on the optical disk in a real-time manner while skipping the defect ECC blocks of the number which is equal to or less than the maximum skipped contiguous ECC block number.

### INCORPORATION BY REFERENCE

The present application claims priority from Japanese application JP2005-107017 filed on Apr. 4, 2005, the content of which is hereby incorporated by reference into this application.

### BACKGROUND OF THE INVENTION

1. Field of the Invention

This invention relates to a technique of recording digital data onto a recording medium such as an optical disk or the like and, more particularly, to a technique of recording data in which an interruption of a predetermined interval or more is not permitted in a recording process or a reproducing process of the data upon recording and reproduction of audio visual data (hereinafter, referred to as “AV data”) or the like which is contiguously inputted or outputted, that is, digital data in which real-time streaming performance is required in the recording and reproduction.

2. Description of the Related Art

As an example of an apparatus for recording and reproducing digital data onto/from a recording type optical disk, a recording/reproducing apparatus (DVD-RAM drive) based on the DVD-RAM standard has been known (“120 mm DVD Rewritable Disk (DVD-RAM)”, ECMA-272, European Computer Manufacturer Association, 1998 (particularly, pages 43-55)). The DVD-RAM drive records the data into a user area of a DVD-RAM disk in compliance with a write command from a host. When the recording of the data fails, the reliability of the data recording is improved by executing a linear replacement for recording the recording-failed data into a spare area as a spare recording area which has previously been provided for the DVD-RAM disk.

JP-A-2000-285610 (particularly, paragraphs [0092]-[0108], and [0206]) discloses a construction in which when the data recording into a defect area in the user area on the optical disk fails, the defect area is skipped and the AV data is recorded into a subsequent normal user area. Thus, the following effect at the paragraph [0206] is accomplished: “The defect area existing in a logical space which is managed by file control information is skipped, thereby enabling the data to be recorded and reproduced. Therefore, although the linear replacement in a physical space where a delay occurs is executed to provide an error-free space as a logical space according to the conventional defect managing method, the high-speed defect managing method whereby the defect area is merely skipped can be provided.”.

### SUMMARY OF THE INVENTION

A DVD recorder has been known as an optical disk drive for recording AV data onto the recording type optical disk such as a DVD-RAM disk or the like. There is a method whereby television programs or the like of a plurality of channels are time-divisionally recorded onto a recording type DVD disk by using such a feature of the DVD recorder that a random access to an arbitrary recording area may be performed.

However, in both of ECMA-272 and JP-A-2000-285610, nothing is disclosed about how to arrange and record the digital data of each channel onto the optical disk when a plurality of channels of the digital data in which the real-time streaming performance is required in recording or reproduction are time-divisionally recorded. That is, both of them do not disclose a method and an apparatus for avoiding a dropout of reproduction data which is caused when a reproducing process of the digital data is interrupted for a predetermined time or longer when the digital data is reproduced.

This invention provides a recording method of time-divisionally recording a plurality of channels of digital data in which real-time streaming performance is required in reproduction, whereby a dropout of reproduction data upon reproduction is prevented.

The object of this invention is accomplished by one of the following methods (1) to (3).

(1) A digital data recording method of recording digital data in which real-time streaming performance is required in recording and reproduction onto an optical disk, comprising the steps of:
assuring a recording area, every channel, which is larger than a minimum contiguous recording area size as a minimum size in which the digital data can be contiguously recorded;
time-divisionally executing the recording of the digital data of a first channel and the recording of the digital data of a second channel into the assured recording area;
when there is a defect block during a recording process of the digital data of the first channel, recording the digital data of the first channel while skipping the defect block; and
when there is a defect block during a recording process of the digital data of the second channel, recording the digital data of the second channel while skipping the defect block.

(2) A digital data recording method of recording digital data in which real-time streaming performance is required in recording and reproduction onto an optical disk, comprising the steps of:
when the digital data of a plurality of channels is time-divisionally recorded, setting a minimum contiguous recording area size as a minimum size in which the digital data can be contiguously recorded and a maximum skipped contiguous block number as the maximum number of blocks of the contiguous recording areas which can be skipped, and further setting a recording area larger than the minimum contiguous recording area size into each channel; and
when the digital data of a predetermined channel is recorded, contiguously recording the digital data of the channel in the recording area set in the channel while skipping the contiguous defect blocks of the number smaller than the maximum skipped contiguous block number.

(3) A digital data recording method of recording digital data in which real-time streaming performance is required in recording and reproduction onto an optical disk, comprising the steps of:
when the digital data of a plurality of channels is time-divisionally recorded, setting, every channel, a minimum contiguous recording area size as a minimum size in which the digital data can be contiguously recorded, a maximum skipped contiguous block number as the maximum number of contiguous blocks of the contiguous recording areas which can be skipped, and a recording area larger than the minimum contiguous recording area size; and
when the digital data of a predetermined channel is recorded, contiguously recording the digital data of the channel in the recording area set in the channel while skipping the contiguous defect blocks of the number smaller than the maximum skipped contiguous block number.

Other objects, features and advantages of the invention will become apparent from the following description of the embodiments of the invention taken in conjunction with the accompanying drawings.

### BRIEF DESCRIPTION OF THE DRAWINGS

FIG. 1 is a system diagram of first and second embodiments of this invention;

FIG. 2 shows a data frame;

FIG. 3 shows an ECC block;

FIG. 4 shows an AV recorder and an optical disk drive of this invention;

FIG. 5 shows a correspondence between a logical address space and a physical address of an optical disk;

FIG. 6 is a system diagram of a third embodiment of this invention;

FIG. 7 is a system diagram of a fourth embodiment of this invention;

FIG. 8 shows recording areas on the optical disk;

FIG. 9 shows a deciding method of a real-time streaming data recording start position;

FIG. 10 shows a construction of a write command for skip recording;

FIG. 11 further shows a deciding method of the real-time streaming data recording start position;

FIG. 12 shows a construction of a recording area setting command; and

FIG. 13 shows a layout of the designated recording areas on the optical disk and a relation between a logical address and the optical disk.

### DETAILED DESCRIPTION OF THE EMBODIMENTS

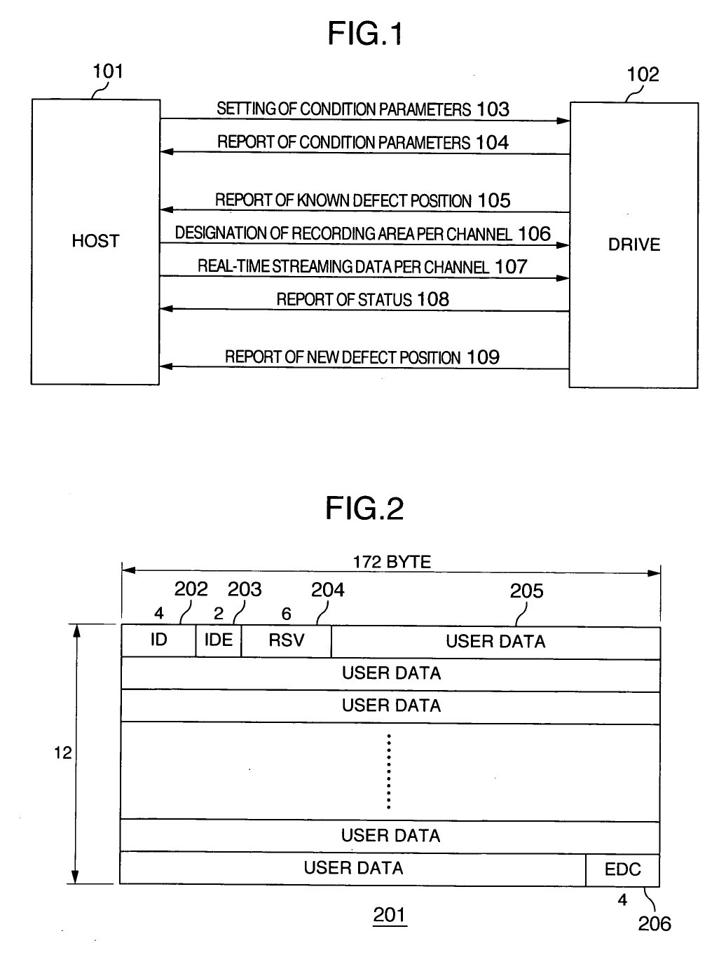

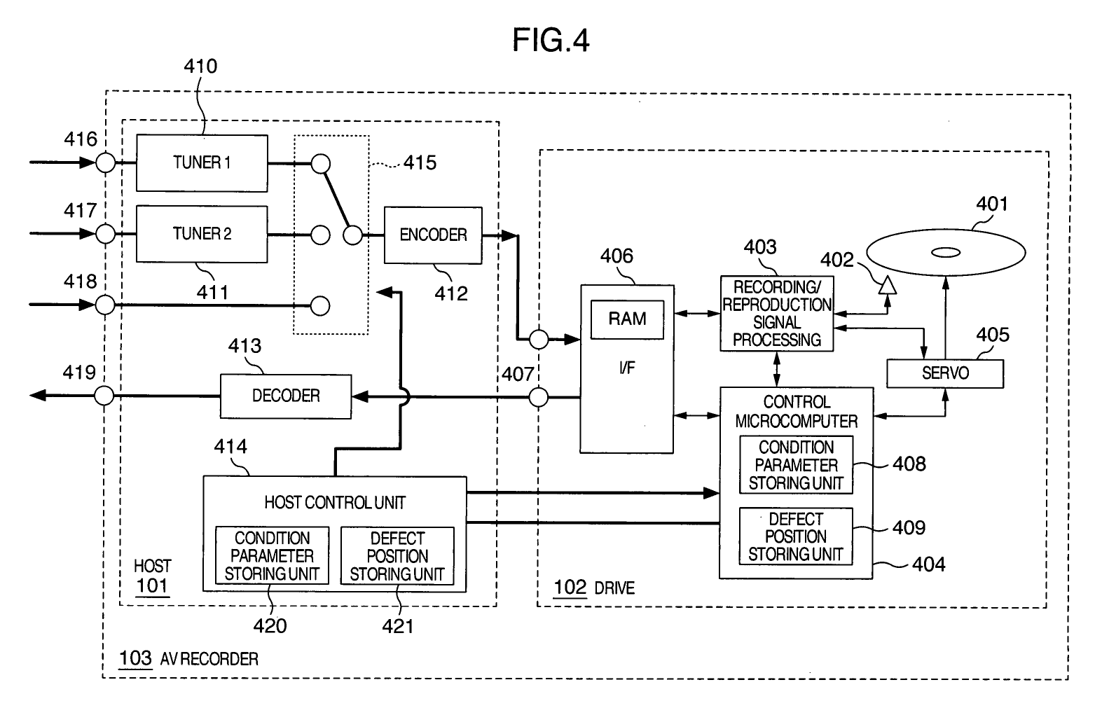

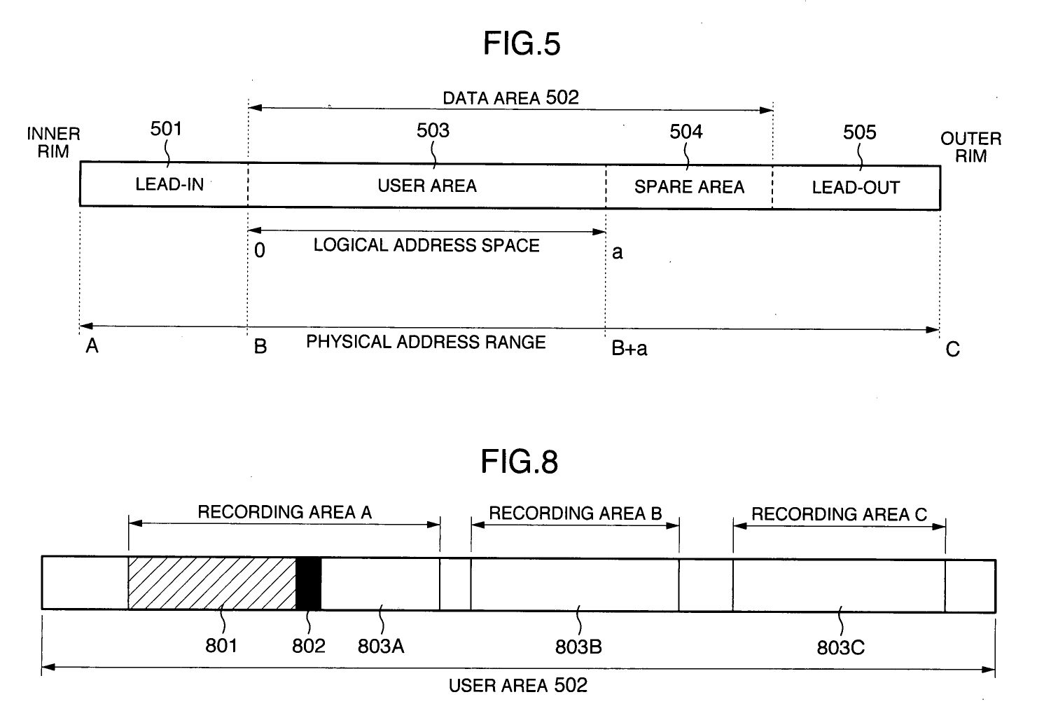

The first embodiment of this invention will now be described with reference to FIGS. 1 to 5. FIG. 1 shows data which is transmitted and received between a host 101 and an optical disk drive 102 (hereinafter, referred to as a “drive 102”) in an AV recorder 103, which will be explained in FIG. 4.

First, constructions of the AV recorder 103 and the drive 102 in the embodiment will be described with reference to FIG. 4. In the drive 102 in FIG. 4, reference numeral 401 designates an optical disk such as a DVD-RAM disk; 402 an optical head on which a laser diode and a photodetector are mounted; 403 a recording/reproduction signal processing circuit for executing a coding process for recording and a decoding process for reproducing; 404 a control microcomputer for controlling the optical head 402 and the recording/reproduction signal processing circuit 403; 405 a servo circuit for controlling the rotation of the optical disk; 406 an interface circuit (I/F circuit) with a host including a RAM; and 407 an input/output terminal (I/O terminal) connected to the host 101. The control microcomputer 404 includes: a condition parameter storing unit 408 for storing condition parameters, which will be explained hereinafter; and a defect position storing unit 409 for storing information of a defect position, which will be explained hereinafter.

The host 101 includes: a first input terminal 416 and a second input terminal 417 each for inputting real-time streaming data which is broadcasted or the like; a third input terminal 418 for inputting real-time streaming data which is transmitted from an external apparatus; a first tuner 410 for receiving an input signal of the first input terminal 416; a second tuner 411 for receiving an input signal of the second input terminal 417; a switch 415 for switching the input signal from the first tuner, the second tuner, or the third input terminal and outputting the switched input signal; an encoder 412 for encoding the real-time streaming data from the switch 415; a decoder 413 for decoding the real-time streaming data which is inputted from the drive 102; an output terminal 419 for outputting the real-time streaming data decoded by the decoder 413; and a host control unit 414 for transmitting information to and receiving it from the control microcomputer 404 of the drive 102.

First, a reproducing process will be described. The data recorded on the optical disk 401 is read out from the optical head 402 and subjected to a decoding process in the recording/reproduction signal processing circuit 403. The decoding process includes (1) a de-modulation process, (2) an error correction process, and (3) a de-scramble process. User data obtained after the decoding process is stored into the RAM in the I/F circuit 406 and, thereafter, outputted to the host 101 through the I/O terminal 407. At this time, the control microcomputer 404 receives a command from the host 101, accesses a target position on the set optical disk 401 while making rotation control of the optical disk 401 and focusing and tracking control of the optical head 402 by using the servo circuit 405, and makes reproduction control of the whole drive.

The reproduced user data is decoded by the decoder 413 and outputted to a monitor and a speaker (not shown) through the output terminal 419.

The recording process will now be described. The real-time streaming data inputted from one of the first tuner, the second tuner and the third input terminal is selected by the switch 415 and encoded by the encoder 412. At this time, the switch 415 is controlled by the host control unit 414 and time-divisionally outputs the inputted real-time streaming data to the encoder 412. The user data obtained by encoding the real-time streaming data inputted to the encoder 412 through the switch 415 is inputted to the drive 102 through the I/O terminal 407, stored into the RAM in the I/F circuit 406, and thereafter subjected to coding processes such as (1) scramble process, (2) error correction coding process and (3) modulation process by the recording/reproduction signal processing circuit 403, and subsequently written onto the optical disk 401 through the optical head 402. At this time, the control microcomputer 404 receives a command from the host control unit 414, accesses a recording position on the set optical disk 401 by using the servo circuit 405, and makes recording control of the whole drive.

Although the construction using the two tuners in order to record a plurality of kinds of broadcasting real-time streaming data in parallel is used in the above description, a construction in which a plurality of kinds of real-time streaming data are extracted by one tuner may be also used. Although the construction having the encoder 412 is shown on the assumption that the real-time streaming data which is inputted is analog data, when the real-time streaming data which is inputted is encoded digital data, a construction in which the encoder 412 is not provided may be also used.

A format of the optical disk and a relation between a physical address and a logical address is described with reference to FIG. 5. As shown, the optical disk is logically divided into a lead-in 501, a data area 502 and a lead-out 505. The data area 502 is further logically divided into a user area 503 and a spare area 504. A start physical address of the lead-in 501 is A, a start physical address of the data area 502 is B and an end physical address of the lead-out 505 is C.

In the initial state where the linear replacement described in conjunction with the DVD-RAM is not executed, the logical address is allocated only to the user area 503 and, for example, a “physical address B+n” and a “logical address n” are made to correspond to each other. When there is a defect in the “physical address B+n”, the linear replacement to allocate the “logical address n” to the spare area 504 is executed.

Information regarding defect management such as linear replacement is registered as a defect list onto the optical disk. For example, in the case of the DVD-RAM disk, the defect list is recorded in the lead-in 501 or the lead-out 505.

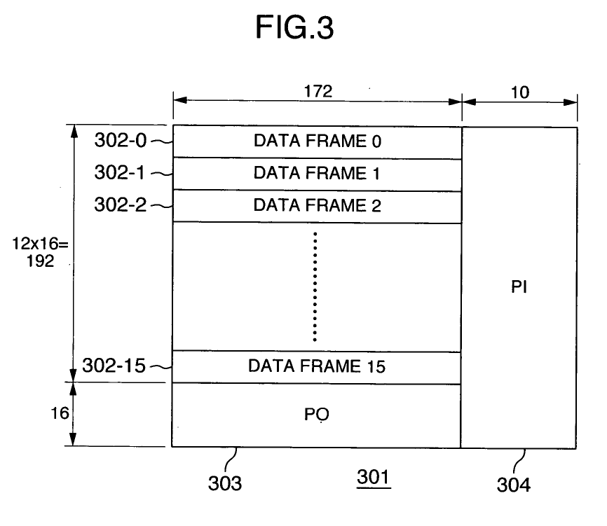

Processes in which the user data inputted from the I/O terminal 407 is constructed in an error correction code block (hereinafter, referred to as an “ECC block”) as a recording/reproduction unit in the data area 502 of the optical disk will now be described with reference to FIGS. 2 and 3.

FIG. 2 shows a data frame 201 constructed by the user data inputted from the I/O terminal 407 and user data control information. A data identification code (ID) 202 of four bytes, an error detection code (IDE) 203 of the ID of two bytes, and a reserved area (RSV) 204 of six bytes are added before the user data of 2048 bytes. Further, an error detection code (EDC) 206 of four bytes is added after the user data. Thus, the data frame 201 of 172 bytes×12 rows (2064 bytes) is constructed.

FIG. 3 shows a construction of an ECC block 301. An outer code (PO) 303 of 16 bytes is added to each column in the vertical direction of 16 data frames constructed by data frames 0 to 15 (302-0 to 302-15). An inner code (PI) 304 of 10 bytes is added to each row in the lateral direction of the 16 data frames and the outer code (PO) 303. Thus, the ECC block 301 of 182 bytes×208 rows is constructed.

The existing DVD-RAM drive executes what is called a verifying process in which just after the data was recorded onto the DVD-RAM disk, the recording data is reproduced and compared with the user data remaining in the RAM of the driver 102, thereby discriminating whether or not the data is normally recorded, and when the data is not normally recorded, it is recorded again. As a method of re-recording in the verifying process, there are (1) a recording method of re-recording the data to the same position (address) and (2) a recording method of recording the data into the space area.

However, according to the first method, when the position where the recording failed is a position where the recording is physically impossible, even when the re-recording is executed, the data cannot be recorded, so that the real-time streaming performance in the data recording is deteriorated. That is, it is difficult to use this method when the real-time streaming data such as AV data is recorded.

Further, according to the second method as well, since the seeking operation is necessary to move the optical head to the spare area, the real-time streaming performance in the data recording is deteriorated and it is difficult to use this method when the real-time streaming data such as AV data is recorded.

That is, there is such a problem that when the foregoing verifying process is executed in case the real-time streaming data is recorded, the real-time streaming data is not properly recorded. Such a problem is further enhanced when it is intended to record the real-time streaming data of a plurality of channels.

In the system of FIG. 1, various condition parameters to record the real-time streaming data are set into the drive 102 from the host 101 before the drive 102 actually records the real-time streaming data (103). There are the following condition parameters which are set.

(1) A “minimum contiguous recording area size 103A” as a minimum size of the recording areas which are physically contiguous. This area size 103A is necessary in the case where a video image and an audio sound included in the real-time streaming data are reproduced in a seamless manner without falling into disorder when the optical disk is reproduced at a one-time speed.

(2) A “maximum skipped contiguous block number 103B” as the maximum number of ECC blocks of the contiguous recording areas which is skipped. This block number 103B is necessary in the case where a video image and an audio sound included in the real-time streaming data are reproduced in a seamless manner without falling into disorder when the optical disk is reproduced at a one-time speed.

(3) A “maximum skipped recording area size 103C” as a recording area size corresponding to the maximum skipped contiguous block number 103B.

(4) An “average data transfer rate 103D” as an average rate of the data transfer in the recording area which is defined by the minimum contiguous recording area size 103A.

The reason why the parameter of (1) is set is that contiguousness of a certain extent is needed in the recording area in order to reproduce the real-time streaming data in a seamless manner. The reason why the parameters of (2) and (3) mentioned above are set is that in order to reproduce the real-time streaming data in a seamless manner, the recording area in which the preceding real-time streaming data is recorded and the recording area in which the subsequent real-time streaming data is recorded need to be close to a certain extent. According to the optical disk recorded so as to satisfy the above conditions (1), (2) and (3), even when it is reproduced by a drive which reproduces only at the one-time speed, the real-time streaming data is reproduced in a seamless manner.

The condition parameters actually used by the drive 102 in compliance with the condition parameters 103A, 103B, 103C and 103D are reported (104) to the host 101. There are the following condition parameters which are reported.

(1) A size which is obtained from the performance of the disk and the drive such as seeking time to access the designated address and data recording speed. Specifically speaking, a “use minimum contiguous recording area size 104A” as a larger one of the “minimum contiguous recording area size 103A” and the “minimum contiguous recording area size” which is necessary when the average data transfer rate 103D is realized by the performance of the drive 102”.

(2) A “use maximum skipped contiguous block number 104B” as a smaller one of the “maximum skipped contiguous block number 103B” and the “maximum number of skip-possible ECC blocks which are necessary when the average data transfer rate 103D is realized by the performance of the drive 102”.

(3) A “use maximum skipped recording area size 104C” as a recording area size corresponding to the use maximum skipped contiguous block number 104B.

As mentioned above, the condition parameters which are determined to be proper by the drive 102 in compliance with the condition parameters set into the drive 102 by the host 101 are reported to the host 101. The host 101 makes proper control to the drive 102 in compliance with the reported condition parameters 104. Thus, the preferred recording process of the real-time streaming data is realized.

Although the drive 102 generally uses the condition parameter which is set by the host 101, when the drive 102 is not able to guarantee the proper recording in the case of using the condition parameter 103 which is set by the host 101, the drive 102 reports an error to the host 101. The “guarantee” of the recording used here denotes that it is guarantees that the data transferred from the host is recorded onto the optical disk 401 without a leakage. Therefore, in the situation where the data is being recorded while switching the data of a plurality of channels, when the switching of the channels occurs before the recording area size reaches the use minimum contiguous recording area size, the drive is not able to guarantee that all of the data transferred from the host is recorded onto the disk. Therefore, the drive reports the error showing that the recording area size does not reach the use minimum contiguous recording area size to the host.

Details at the time when the real-time streaming data of a plurality of channels is recorded in the system of FIG. 1 will now be described.

First, the drive 102 reports the defect position which is obtained from the defect list of the optical disk 401 and is not suitable for the recording of the real-time streaming data to the host 101 prior to recording the real-time streaming data (105). The defect position information denotes not only the information merely showing the unusable position but also the position information showing the area which becomes a fault when the data is recorded in a real-time manner because the recording area size is less than the minimum contiguous recording area size. Therefore, even in the case of the logical address which is used for the recording of the data in which the real-time streaming performance in the recording is not required, since the logical address subjected to the linear replacement to the spare area 504 is the defect logical address which is not able to assure the physical contiguousness of the recording area, it becomes an object of the defect position information.

The host 101 sets the recording area of the real-time streaming data in compliance with the condition parameter 104 and defect position information 105 which are reported from the drive 102. In the embodiment, since the real-time streaming data of a plurality of channels is recorded, a plurality of recording areas of the number which is equal to or larger than the number of recording target channels are set. Naturally, the logical address which is not suitable for the recording of the real-time streaming data such as a logical address subjected to the linear replacement is not included in the set recording area.

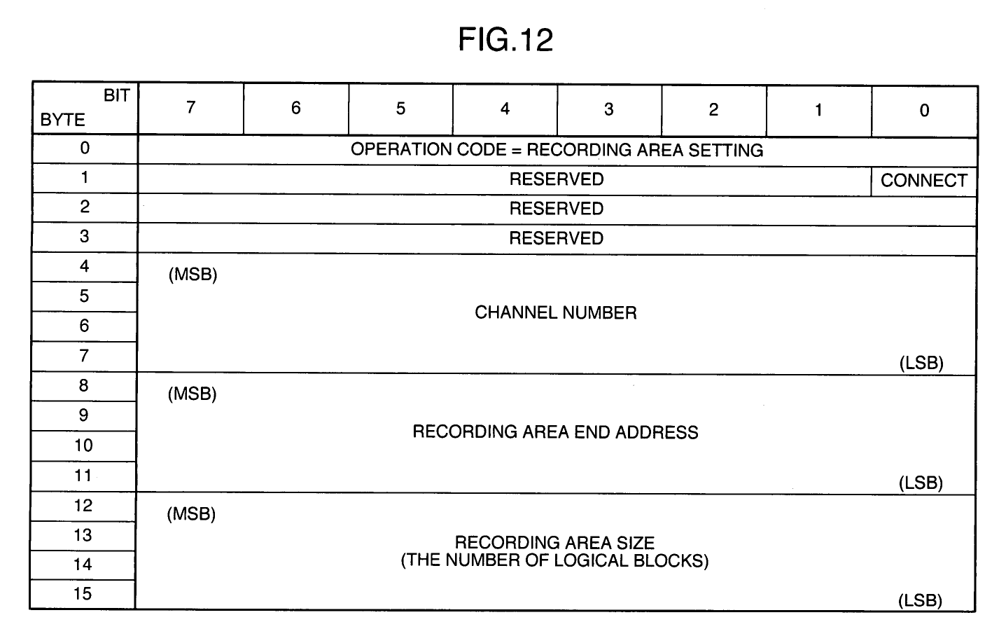

FIG. 12 shows an example of a construction of a recording area setting command which is transmitted from the host 101 to the drive 102 when the recording area is set. The recording area setting command consists of 16 bytes and includes information regarding: an operation code of the recording area setting command; a connection bit as recording area related information showing a relation with the recording area which is already set; the number of the channel in which the recording area is used; and a recording area size which is defined by a recording area end address and the number of logical blocks.

In the system of FIG. 1, after a plurality of recording areas are set, each of the set recording areas and the channel number are set in association with each other in compliance with a channel number 106A which is set (106) from the host 101. When a plurality of recording areas associated with the specific channel number exist, the data is recorded into the recording areas in order set by the host 101 or recorded from the recording area of the small logical address.

The information included in the recording area designation 106 per channel includes the following information.

(1) The “channel number 106A” as a channel number of the real-time streaming data.

(2) “recording area related information 106B” showing whether or not the recording area set just before and the recording area of the same channel which is newly set are handled as one coupled contiguous recording area.

(3) A “recording area end address 106C” as an end address of the recording area.

(4) A “recording area size 106D” as a size of recording area.

A construction in which a “recording area termination address 106E” is set in place of the recording area size 106D is also used.

Although the drive 102 is controlled by using the average data transfer rate 103D in the embodiment, in order to further efficiently perform the switching of a plurality of channels, a “data transfer rate per channel 103E” indicative of the data transfer rate which is necessary for each channel to realize the seamless reproduction is also used in place of the average data transfer rate 103D. At this time, the drive 102 reports the use minimum contiguous recording area size 104A which guarantees the seamless reproduction to the host 101 every channel in compliance with the minimum contiguous recording area size 103A, maximum skipped contiguous block number 103B, maximum skipped recording area size 103C and data transfer rate per channel 103E.

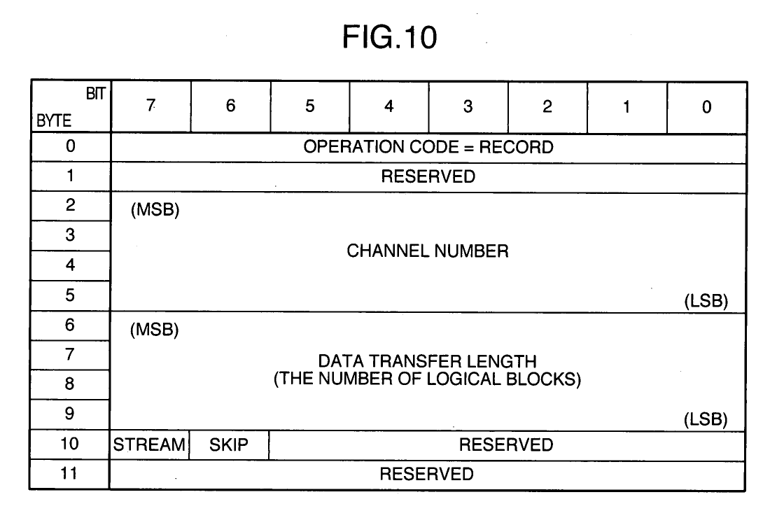

After the foregoing setting and reporting processes, the real-time streaming data of a plurality of channels is actually recorded. An example of a construction of a write command which is transmitted from the host to the drive upon recording the real-time streaming data is shown in FIG. 10. The write command consists of 12 bytes and includes the information regarding: an operation code of the write command; a channel number which specifies the recording position of the real-time streaming data to be transferred; a data transfer length in which an amount of real-time streaming data to be transmitted is defined by the number of logical blocks; a streaming bit showing that the real-time streaming performance is required in the recording of the data to be transferred; and a skipped bit which requests the drive to automatically avoid the defect by executing the skipping process to the new defect.

Although an example in which the real-time streaming data of two channels is recorded in order to simplify the explanation of the recording process of the embodiment will be described hereinbelow, this invention is not limited to such an example but the real-time streaming data of an arbitrary number of channels is also recorded.

First, the real-time streaming data of one channel number is contiguously recorded into the recording area corresponding to the channel number by an amount corresponding to the use minimum contiguous recording area size 104A or more corresponding to the channel number. At subsequent arbitrary timing, the real-time streaming data of the other channel number is contiguously recorded into the recording area corresponding to the channel number by an amount corresponding to the use minimum contiguous recording area size 104A corresponding to the channel number or more. By switching the recording target channels in this manner, the fine channel switching is realized. That is, by using the channel switching method described here, the channel switching efficiency is improved and the apparatus copes with the recording of a larger number of channels.

When the size of unrecording area in the recording set area where the data is at present being recorded is smaller than the use minimum contiguous recording area size 104A as a result of the recording of the real-time streaming data of the specific channel number, the recording of the real-time data of this channel number is continued until the unrecording area is extinguished, and after completion of the recording of the set recording area, the recording of the other channel is also executed. Thus, the occurrence of the unrecording area whose size does not reach the use minimum contiguous recording area size 104A, that is, the unrecording area which is not suitable for the recording of the real-time streaming data is avoided.

By recording the real-time streaming data of a plurality of channels as mentioned above, the data such as AV data in which the real-time streaming performance is required in the recording and reproduction is properly recorded onto the optical disk.

The second embodiment of this invention in which the recording control corresponding to the new defect which is newly detected during the recording process is made will now be described with reference to FIG. 1.

The drive 102 detects the defect area due to the physical factor by using an amount of return light from the disk which is being recording-processed, a servo input signal and address reproducing situation without executing the reproducing process for detecting the defect after the recording process.

When the newly detected defect is detected, the drive 102 discriminates whether or not the new defect is avoided within the ranges of the “use maximum skipped contiguous block number 104B” and the “use maximum skipped recording area size 104C”. When the new defect is avoided by the skipping process, the defect area is skipped and the recording of the real-time streaming data into the subsequent unrecording area is continued.

Under the limitation of the condition parameters 104B and 104C, when the defect area is not avoided by the skipping process, it is necessary to move to another recording area and continue the recording of the real-time streaming data.

The situation where it is necessary to search the recording area again will be described with reference to FIG. 8. In FIG. 8, three recording areas of a recording area A, a recording area B and a recording area C are set in the user area 502. A real-time streaming data recorded area 801, a newly detected defect area 802 and a real-time streaming data unrecording area 803A are included in the recording area A. Each of the recording area B (803B) and the recording area C (803C) is the unrecording area of the real-time streaming data. The unrecording area does not denote an area where no data is recorded but an area where data which is not managed as valid data has been recorded.

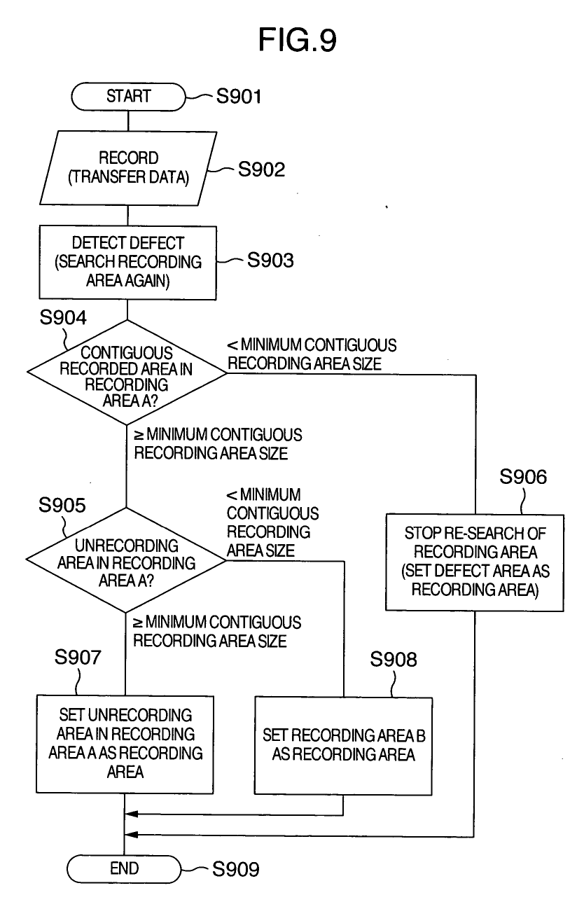

In the situation of FIG. 8, when the newly detected defect area 802 has a size larger than the use maximum skipped contiguous block number 104B, the ordinary skipping process is not executed. A method of discriminating whether, when the new defect is detected, such a new defect is skipped and the recording of the real-time streaming data is restarted, or the recording area is moved to another recording area and the recording of the real-time streaming data is restarted, or the data is forcedly recorded into such a defect area will now be described with reference to a flowchart of FIG. 9.

First, the write command of the real-time streaming data is sent to the drive 102 from the host 101 and the drive 102 executes the recording process in compliance with the write command (S902).

When the new defect area 802 is detected during the recording into the recording area A (S903), a size of contiguous real-time streaming data recorded area 801 in the recording area A is compared with the use minimum contiguous recording area size 104A (S904).

When the size of contiguous real-time streaming data recorded area 801 is smaller than the use minimum contiguous recording area size 104A, the re-searching operation of the recording area is stopped and the recording of the real-time streaming data to be recorded into the defect area 802 is abandoned, or the recording of the data into the defect area 802 is forcedly executed (S906, S909). In the case of abandoning the recording of the real-time streaming data, the real-time streaming data is recorded to the halfway position of the defect area 802 which reaches the use minimum contiguous recording area size 104A. In this case, when the recording area size reaches the use minimum contiguous recording area size 104A, the discrimination about the recording area of step S904 is made again.

When the size of contiguous real-time streaming data recorded area 801 is equal to or larger than the use minimum contiguous recording area size 104A, a size of unrecording area 803A in the recording area A is compared with the use minimum contiguous recording area size 104A (S905).

When the size of unrecording area 803A is smaller than the use minimum contiguous recording area size 104A, the unrecording area 803B in the recording area B is set as a recording area and the recording of the real-time streaming data is restarted (S908, S909).

When the size of unrecording area 803A is equal to or larger than the use minimum contiguous recording area size 104A, the unrecording area 803A is set as a recording area, the defect area 802 is skipped, and the recording of the real-time streaming data is continued (S907, S909).

By the above processes, by deciding the recording restart position and the recording area of the real-time streaming data, after the contiguous recording areas are once interrupted, the contiguous recording is restarted.

Although the recording area B has been set in step S908 here, when the recording area B is set as a recording area of another channel, another recording area such as a recording area C is also set. When the recorded area exists in the recording area B, a construction in which the recorded area in the recording area B is avoided and the real-time streaming data is recorded into the unrecording area in the recording area B is also used. Further, when an area other than the recording area A is not set as an area to record the present channel, a construction in which an error showing the absence of the recording area is reported to the host 101 is also used.

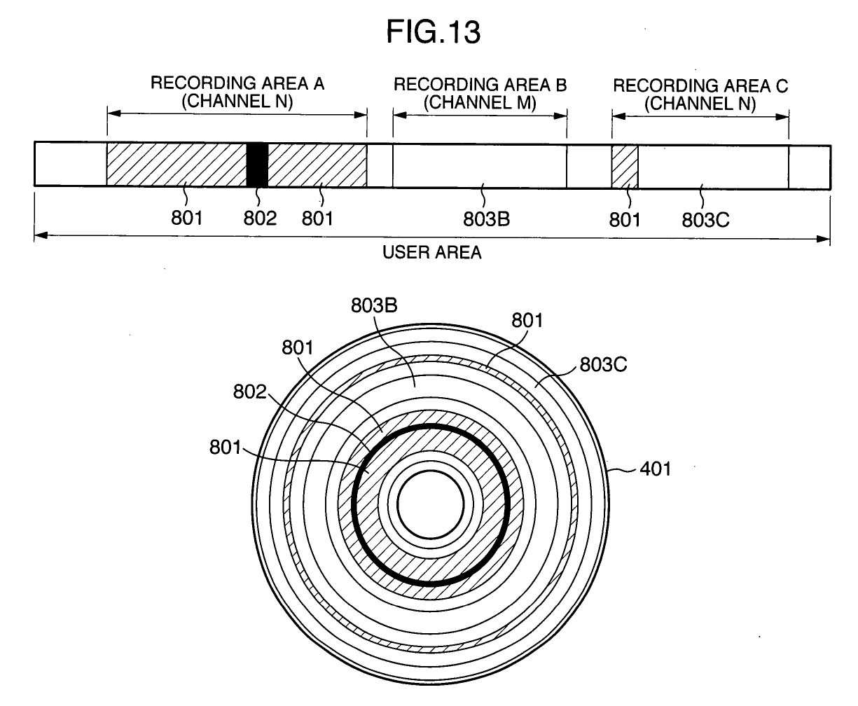

An example of an optical disk on which the real-time streaming data is recorded by using the re-searching process of the recording area mentioned above is shown in FIG. 13. In this example, when the size of contiguous real-time streaming data recorded area 801 reaches the use minimum contiguous recording area size 104A, the size of unrecording area 803A in the recording area A is equal to or larger than the use minimum contiguous recording area size 104A, the unrecording area 803B in the recording area B is allocated to another channel, and the unrecording area 803C in the recording area C is the designated recording area allocated to the area for the present channel, the data is recorded.

After the defect area 802 is detected, the contiguous real-time streaming data recorded area size 801 of a channel N in the recording area A is compared with the use minimum contiguous recording area size 104A previously set. In this instance, since the contiguous real-time streaming data recorded area size 801 reaches the use minimum contiguous recording area size 104A, the size of unrecording area 803A in the recording area A is subsequently compared with the use minimum contiguous recording area size 104A. Since the size of unrecording area 803A in the recording area A is equal to or larger than the use minimum contiguous recording area size 104A, the unrecording area 803A in the recording area A is set as a new recording area, and the recording of the real-time streaming data is continued.

After that, the whole size of unrecording area 803A in the recording area A for the channel N reaches the size of recorded area 801. In a manner similar to the recording area re-searching process at the time of the detection of the defect, whether or not the recording area is the designated recording area for the channel N is discriminated in order of the recording area B (803B) and the recording area C (803C) as unrecording areas. In this instance, since the recording area B (803B) is not the recording area for the channel N but the recording area C (803C) is the recording area for the channel N, the recording area B (803B) is skipped, the recording area C (803C) is used as a next recording area for the channel N, and the recording is continued. Thus, a part of the recording area C becomes the recorded area 801 of the real-time streaming data of the channel N.

A report (108) of a status and a report (109) of a new defect position from the drive 102 to the host 101 will now be described with reference to FIG. 1.

In the system of FIG. 1, when the recording area is automatically searched for again by the processes shown in FIG. 9, it is necessary to interrupt the recording of the real-time streaming data and notify the host 101 that the re-searching process has been executed. Therefore, after completion of the recording of the real-time streaming data of the channel, when the operation is switched from the recording of the real-time streaming data of the channel to the recording of the real-time streaming data of another channel or when a report request is made by the host 101 during the recording process, the report (108) of the status regarding the recording situation is made by the drive 102.

As examples of the status information 108 which is reported to the host 101 by the drive 102, there are the following information.

(1) A “recording end signal 108A to the set recording area” showing that the recording is finished.

(2) A “final recording position 108B in the set recording area” showing the position where the recording is finished.

(3) “next recording position information 108C” showing the position where the recording is restarted.

When the real-time streaming data of a plurality of channels is recorded, the recording end signal 108A to the set recording area is used to decide the timing for performing the channel switching, the timing for performing the report (109) of the new defect position.

In the system of FIG. 1, the report (109) of the new defect position from the drive 102 to the host 101 is performed after the recording to each of the set recording areas is finished. The new defect denotes a defect which is newly detected during the recording of the real-time streaming data and subjected to the skipping process. The presence or absence of the new defect in each of the set recording areas and the position information of the new defect is also reported in accordance with a request from the host 101.

The recording process of the file control information will now be described. The host 101 determines the recording position of the file constructed by the real-time streaming data of each channel from the status 108 and the newly defected defect position 109 which are reported from the drive 102 every channel. When the recording of the real-time streaming data of all channels is paused or after completion of the recording, the file control information to manage those files is recorded onto the optical disk.

It is not always necessary that all of the defects reported as new defects from the drive are registered into the defect list of the optical disk 401. This is because since the new defect detected in the embodiment is the defect area discriminated from the reflection light which is being recording-processed, precision in such a defect area differs from that of the defect area detected by executing the reproducing process after the recording.

According to the second embodiment as described above, by executing the recording of the real-time streaming data while avoiding the newly detected defect area, the recording performance of the real-time streaming data is improved.

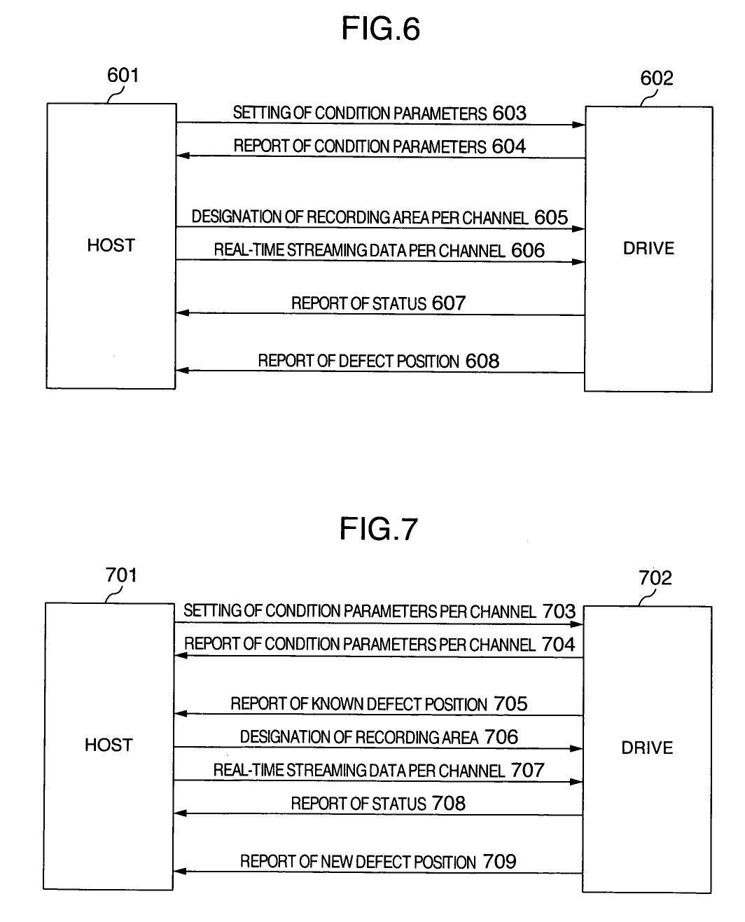

The third embodiment of this invention will now be described with reference to FIG. 6. Since processes 603, 604, 605, 606 and 607 in FIG. 6 correspond to those designated by reference numerals 103, 104, 106, 107 and 108 in FIG. 1, respectively, the detailed description is omitted.

In the system of FIG. 6 including a host 601 and a drive 602, the known defect position is not reported from the drive 602 to the host 601. Therefore, the known defect position is also included in the recording area (605) per channel which is set by the host 601.

In this instance, in the system of FIG. 6, when the situation described with reference to FIG. 8 occurs, the defect area due to the physical factor is detected by using the return light amount, servo input signal and address reproducing situation obtained during the recording, and the processes shown in FIG. 9 described in the second embodiment are executed. Consequently, in a manner similar to the construction shown in the second embodiment, by recording the real-time streaming data while avoiding the defect area, the recording performance of the real-time streaming data is improved. Further, the control is simplified more than that in the construction of the second embodiment.

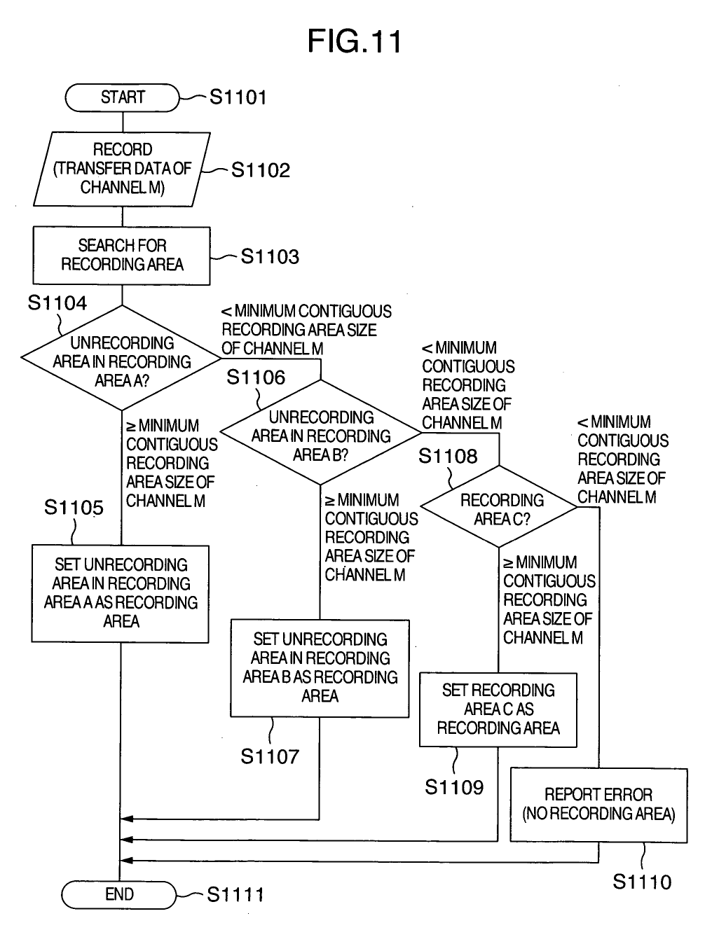

The fourth embodiment of this invention will now be described with reference to FIGS. 7 and 11. Since processes 705, 707, 708 and 709 in FIG. 7 correspond to those designated by reference numerals 105, 107, 108, and 109 in FIG. 1, respectively, the detailed description is omitted.

In the system of FIG. 7 including a host 701 and a drive 702, condition parameters are set (703) into the drive 702 every channel from the host 701. The drive 702 reports (704) the condition parameters per channel to the host 701. A “use minimum contiguous recording area size 704A” which is reported every channel is included in the condition parameters 704 per channel. After that, the host 701 sets a plurality of recording areas without being associated with the channels. In the embodiment, since the recording area is set without being associated with the channel, the recording area of the specific channel whose size is smaller than the use minimum contiguous recording area size 704A is also included in the recording area.

A method of setting the recording area upon channel switching will now be described with reference to FIG. 11 concerning the situation described in FIG. 8 as an example.

First, the write command of the real-time streaming data is sent to the drive 702 from the host 701, the drive 702 starts the recording process in response to the write command (S1102), and searches for the recording area which becomes the recording target first (S1103).

Subsequently, the size of unrecording area 803A in the recording area A is compared with the use minimum contiguous recording area size 704A of the specific channel (for example, channel M) (S1104).

When the size of unrecording area 803A is equal to or larger than the use minimum contiguous recording area size 704A, the unrecording area 803A in the recording area A is set as a recording area and the real-time streaming data is recorded (S1105).

When the size of unrecording area 803A is smaller than the use minimum contiguous recording area size 704A, the size of unrecording area 803B in the recording area B is compared with the use minimum contiguous recording area size 704A of the channel M (S1106).

When the size of unrecording area 803B is equal to or larger than the use minimum contiguous recording area size 704A, the unrecording area 803B in the recording area B is set as a recording area and the real-time streaming data is recorded (S1107).

When the size of unrecording area 803B is smaller than the use minimum contiguous recording area size 704A, the size of unrecording area 803C in the recording area C is compared with the use minimum contiguous recording area size 704A of the channel M (S1108).

When the size of unrecording area 803C in the recording area C is equal to or larger than the use minimum contiguous recording area size 704A, the unrecording area 803C in the recording area C is set as a recording area and the real-time streaming data is recorded (S1109).

When the size of unrecording area 803C is smaller than the use minimum contiguous recording area size 704A, the host 701 is notified that the proper recording area does not exist (S1108).

In the system of FIG. 7, even when the new defect is detected during the recording process, by executing the processes shown in FIG. 9, the proper recording process in which the defect area is avoided is executed.

It should be further understood by those skilled in the art that although the foregoing description has been made on embodiments of the invention, the invention is not limited thereto and various changes and modifications may be made without departing from the spirit of the invention and the scope of the appended claims.

1. A digital data recording method of recording digital data in which real-time streaming performance is required in recording and reproduction onto an optical disk, comprising the steps of:
assuring a recording area, every channel, which is larger than a minimum contiguous recording area size as a minimum size in which the digital data is contiguously recorded;
time-divisionally executing the recording of the digital data of a first channel and the recording of the digital data of a second channel into the assured recording area;
recording the digital data of the first channel while skipping a defect block when there is the defect block during a recording process of the digital data of the first channel; and
recording the digital data of the second channel while skipping a defect block when there is the defect block during a recording process of the digital data of the second channel.

2. A digital data recording method of recording digital data in which real-time streaming performance is required in recording and reproduction onto an optical disk, comprising the steps of:
when the digital data of a plurality of channels is time-divisionally recorded, setting a minimum contiguous recording area size as a minimum size in which the digital data can be contiguously recorded and a maximum skipped contiguous block number as the maximum number of blocks of the contiguous recording areas which can be skipped, and further setting a recording area larger than the minimum contiguous recording area size into each channel; and
when the digital data of a predetermined channel is recorded, contiguously recording the digital data of the channel in the recording area set in the channel while skipping the contiguous defect blocks of the number smaller than the maximum skipped contiguous block number.

3. A method according to claim 2, wherein when the recording area larger than the minimum contiguous recording area size is set, a channel switching condition is set so that a channel number and a data transfer rate of the channel are associated with each other.

4. A method according to claim 2, wherein when the contiguous defect blocks of the number larger than the maximum skipped contiguous block number are included in the minimum contiguous recording area size, the recording area is searched for again in the recording area of the channel so as to satisfy the minimum contiguous recording area size.

5. A digital data recording method of recording digital data in which real-time streaming performance is required in recording and reproduction onto an optical disk, comprising the steps of:
when the digital data of a plurality of channels is time-divisionally recorded, setting, every channel, a minimum contiguous recording area size as a minimum size in which the digital data is contiguously recorded, a maximum skipped contiguous block number as the maximum number of contiguous blocks of the contiguous recording areas which is skipped, and a recording area larger than the minimum contiguous recording area size; and
when the digital data of a predetermined channel is recorded, contiguously recording the digital data of the channel in the recording area set in the channel while skipping the contiguous defect blocks of the number smaller than the maximum skipped contiguous block number.

6. A method according to claim 5, wherein when the recording area larger than the minimum contiguous recording area size is set, a channel switching condition is set so that a channel number and a data transfer rate of the channel are associated with each other.

7. A method according to claim 5, wherein when the contiguous defect blocks of the number larger than the maximum skipped contiguous block number are included in the minimum contiguous recording area size, the recording area is searched for again in the recording area of the channel so as to satisfy the minimum contiguous recording area size.

8. An optical disk drive for time-divisionally recording digital data of a plurality of channels which is transferred from a host and in which real-time streaming performance is required in recording and reproduction onto an optical disk, comprising:
an interface for receiving control data and user data from an external host;
a signal processing circuit for signal-processing the data inputted from the interface;
an optical head for recording the data onto the optical disk;
a servo for controlling rotation of the optical disk; and
control means for controlling the interface, the signal processing circuit and the servo,
wherein the control means reports a recording condition determined in compliance with a recording condition included in the control data sent from the external host to the external host.

9. An optical disk drive for time-divisionally recording digital data of a plurality of channels which is transferred from a host and in which real-time streaming performance is required in recording and reproduction onto an optical disk, comprising:
an interface for receiving control data and user data from an external host;
a signal processing circuit for signal-processing the data inputted from the interface;
an optical head for recording the data onto the optical disk;
a servo for controlling rotation of the optical disk; and
control means for controlling the interface, the signal processing circuit and the servo,
wherein the control means sets a defect area that is not suitable for recording the digital data in which the real-time streaming performance is required in the recording and the reproduction in compliance with the control data sent from the external host and sets a plurality of recording areas each of which does not include the defect area into the optical disk.

10. A drive according to claim 9, wherein the control means allows each channel to be associated with each recording area and records the data of the channel associated with each recording area.

11. An AV recorder comprising:
an optical disk drive for time-divisionally recording digital data of a plurality of channels in which real-time streaming performance is required in recording and reproduction onto an optical disk; and
a host for transmitting the digital data of the plurality of channels to the optical disk drive and controlling the optical disk drive,
wherein the host sets a defect area that is not suitable for recording the digital data in which the real-time streaming performance is required in recording and reproduction and sets a plurality of recording areas each of which does not include the defect area into the optical disk.

12. A recorder according to claim 11, wherein the host controls the optical disk drive so as to allow each channel to be associated with each recording area and record the data of the channel associated with each recording area.

13. An AV recorder comprising:
an optical disk drive for time-divisionally recording digital data of a plurality of channels in which real-time streaming performance is required in recording and reproduction onto an optical disk; and
a host for transmitting the digital data of the plurality of channels to the optical disk drive and controlling the optical disk drive,
wherein the host sets a recording condition into the optical disk drive, the optical disk drive reports the recording condition determined in compliance with the recording condition to the host, and the host controls the optical disk drive in compliance with the recording condition reported from the optical disk drive.

14. An AV recorder comprising:
an optical disk drive for time-divisionally recording digital data of a plurality of channels in which real-time streaming performance is required in recording and reproduction onto an optical disk; and
a host for transmitting the digital data of the plurality of channels to the optical disk drive and controlling the optical disk drive,
wherein the host sets a recording condition into the optical disk drive, and when the recording under the recording condition is impossible, the optical disk drive reports information showing that the recording under the recording condition is impossible to the host.
